(19) United States
(12) Patent Application Publication
(10) Pub. No.: US 2026/0134779 A1
(43) Pub. Date: May 14, 2026

(54) UPLOADING FLIGHT DATA TO A SERVER SYSTEM

(71) Applicant: Honeywell International Inc., Charlotte, NC (US)

(72) Inventors: Kalimulla Khan, Bangalore (IN); Subhransu Sahoo, Bengaluru (IN); Srilakshmi Kurudi, Bangalore (IN); Srihari Jayathirtha, Peoria, AZ (US)

(21) Appl. No.: 19/094,446

(22) Filed: Mar. 28, 2025

(30) Foreign Application Priority Data
Nov. 13, 2024 (IN) 202411087778

(51) Int. Cl. G08G 5/23

(52) U.S. Cl. CPC G08G 5/23

(57) ABSTRACT

A client system for uploading flight data to a server system is configured to receive flight data for a flight, wherein the flight data includes flight identification data and parameter data obtained from a flight data recorder of an aircraft, wherein the parameter data comprises values for a plurality of parameters, each of the plurality of parameters being associated with a status of the aircraft and each of the values being associated with a timestamp; modify the flight data to generate modified flight data by detecting a field in the flight data and changing a value associated with the field; and transmit the modified flight data to the server system.

This application claims the benefit of IN Provisional Patent Application No. 202411087778, filed 13 November 2024, the entire contents of which is incorporated herein by reference.

### TECHNICAL FIELD

This disclosure relates to communication between aircraft systems and external servers.

### BACKGROUND

Vehicle operation and route planning technology increasingly relies on computer-based systems for obtaining current, most up-to-date data in order to determine an efficient and economical navigation plan. Vehicle operation and route planning technology also increasingly relies on computer-based systems to analyze past data in order to determine if a flight was flown in an efficient manner and to determine how operations can be improved. Such computation not only involves data captured and kept on-board the vehicle, but also involves data collected and analyzed off-board, such as by cloud-based analytics services.

### SUMMARY

This disclosure describes a flight data obfuscation engine, implemented primarily in software, that may be installed on a client system, such as an airline server. The flight data obfuscation engine may be configured to modify flight data prior to the client system transmitting the flight data to an external server system, such as a third party analytics provider. The flight data obfuscation engine may be customizable and modifiable by a user, e.g., an employee of the airline. The flight data obfuscation engine of this disclosure may provide a secure mechanism to automatically filter and format airline flight data to comply with confidentiality requirements, for example, to safeguard the identity of crew and flight information. By automating the filtering and formatting of the flight data, a system implementing the flight data obfuscation engine may provide data to third party analytics providers in a more-timely manner. Additionally, the flight data obfuscation engine may receive analytics data associated with the modified flight data and associate that analytics data with the unmodified data. For example, if the modified data has information such as pilot names and route information removed, the flight data obfuscation engine may be configured to add back the removed pilot names and route information.

According to an example of this disclosure, a computer-implemented method of uploading flight data to a server system includes: receiving, by a client computing system, flight data for a flight, wherein the flight data includes flight identification data and parameter data obtained from a flight data recorder of an aircraft, wherein the parameter data comprises values for a plurality of parameters, each of the plurality of parameters being associated with a status of the aircraft and each of the values being associated with a timestamp; modifying, by a flight data obfuscation engine executing on the client computing system, the flight data to generate modified flight data, wherein modifying the flight data comprises detecting a field in the flight data and changing a value associated with the field; and transmitting the modified flight data to the server system.

According to an example of this disclosure, a client system for uploading flight data to a server system includes: one or more memories; and processing circuitry coupled to the one or more memories and configured to: receive flight data for a flight, wherein the flight data includes flight identification data and parameter data obtained from a flight data recorder of an aircraft, wherein the parameter data comprises values for a plurality of parameters, each of the plurality of parameters being associated with a status of the aircraft and each of the values being associated with a timestamp; modify the flight data to generate modified flight data, wherein to modify the flight data, the processing circuitry is configured to detect a field in the flight data and change a value associated with the field; and transmit the modified flight data to the server system.

The details of one or more examples are set forth in the accompanying drawings and the description below. Other features, objects, and advantages will be apparent from the description, drawings, and claims.

### BRIEF DESCRIPTION OF DRAWINGS

FIG. 1 shows an overview of an example computing environment in which techniques of the present disclosure may be implemented.

FIG. 2A shows a system for uploading flight data to a server system in accordance with the techniques of this disclosure.

FIG. 2B shows a system for receiving flight analytics data in accordance with the techniques of this disclosure.

FIG. 3 illustrates an example of an airline client system in accordance with techniques of this disclosure.

FIG. 4 illustrates an example of an analytics sever system in accordance with techniques of this disclosure.

FIG. 5 shows an example of a computing device for executing EFB applications in accordance with techniques of this disclosure.

FIG. 6 shows an example of an avionics system in accordance with techniques of this disclosure.

FIG. 7 is a flowchart showing an example process for communicating with an analytics server in accordance with techniques of this disclosure.

Throughout the figures, like reference numerals across multiple figures refer to the same hardware, software, data, step, etc.

### DETAILED DESCRIPTION

Flight data analytics providers rely on flight data to be provided by airlines for analysis and insights. Timely dissemination of data from airlines is a challenge due to the sensitivity of the flight data. Regulations, airline policies, and pilot union guidelines for maintaining the confidentiality of certain types of identity information associated with flight data require data to be altered before transmission. Airlines also closely guard operational data from being used by competitors to gain insights into how airlines operates. Many airlines manually filter flight data based on company policies before providing the data to third party service providers.

This manual processing by the airlines potentially delays analysis and insights for weeks and potentially causes the airlines to miss time-sensitive insights like maintenance issues. This processing may also anonymize data in a manner that causes some key performance indicators based on crew behavior or patterns to be missed. For example, flight analytics providers may be able to provide fleet level or aircraft class level analysis, but due to a lack of crew identification information, the flight data analytics providers cannot provide crew level analysis. Additionally, non-standard pre-processing of data by airlines increases on-boarding time by the third party analytics service providers due to customer specific customization, and analysis often takes longer due to additional processing resulting from missing or filtered data.

This disclosure describes a flight data obfuscation engine, implemented primarily in software, that may be installed on a client system, such as an airline server. The flight data obfuscation engine may be configured to modify flight data prior to the client system transmitting the flight data to an external server system, such as a third party analytics provider. The flight data obfuscation engine may be customizable and modifiable by a user, e.g., an employee of the airline. The flight data obfuscation engine of this disclosure may provide a secure mechanism to automatically filter and format airline flight data to comply with confidentiality requirements, for example, to safeguard the identity of crew and flight information. By automating the filtering and formatting of the flight data, a system implementing the flight data obfuscation engine may provide data to third party analytics providers in a more-timely manner. Additionally, the flight data obfuscation engine may receive analytics data associated with the modified flight data and associate that analytics data with the unmodified data. For example, if the modified data has information such as pilot names and route information removed, the flight data obfuscation engine may be configured to add back the removed pilot names and route information.

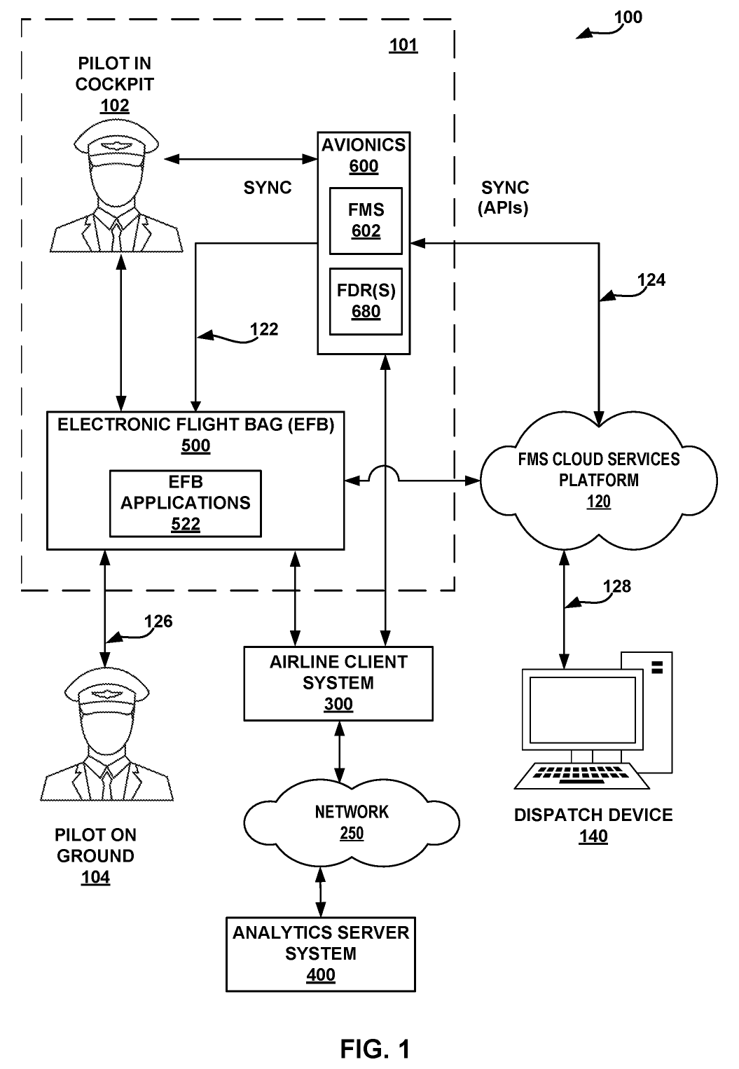

FIG. 1 shows an overview of an example computing environment 100, according to one or more examples of the present disclosure. In environment 100, EFB 500 is configured to communicate with avionics 600. EFB 500 and avionics 600 are both devices or systems that may be located inside aircraft 101. Environment 100 also includes a connected FMS cloud services platform 120 (platform 120) and a dispatcher device 140, which may be located outsider of aircraft 101, as well as airline client system 300, which is configured to receive raw flight data from EFB 500 or avionics 600 and then transmit modified flight data to analytics server system 400 via network 250. Network 250 may, for example, be an internet-based network.

EFB 500 may be a computer device carried by a pilot or a flight crew, which may store, for example, navigational charts, maps for air and ground operations of an aircraft, a flight plan management system, an aircraft operating manual, flight-crew operating manual, software applications which automate flight-related or avionics-related computation tasks, and/or any application or data which may be installed in a general purpose computing platform. EFB 500 may include a pilot information display (PID).

Avionics 600 generally represents any electronic systems that may be implemented in an aircraft. Avionics 600 may, for example, perform functions related to communication, navigation, safety monitoring, and other such functionality. Avionics 600 includes FMS 602, which represents a specialized computer system configured to automate in-flight tasks according to a flight plan. Dispatcher device 140 may be any computer device which may be accessed by a user who performs planning, flying, navigating, or managing tasks associated with aircraft, airspaces, airports, or flight plans. Accordingly, the user is not limited to a dispatcher, and the dispatcher device 140 is not limited to a device of a dispatcher. The connected FMS cloud services platform 120 may be a cloud-based platform that provides FMS services to any user who has authorized access to the platform.

As shown in FIG. 1, the environment 100 may accommodate access by various types of users. For example, a pilot 102, who may be in cockpit, may have access to EFB 500 and EFB applications 522 installed on EFB 500. Pilot 102 may also have access to avionics 600 and FMS 602, through which pilot 102 may access the connected FMS cloud services platform 120. EFB applications 522 may access connected FMS cloud services platform 120 and provide the FMS services to the users of EFB 500 in which the EFB applications 522 are installed. In that way, EFB 500 may provide to pilot 102 user-friendly and customized user interfaces, by which pilot 102 may interact with FMS services from the platform 120.

FMS 602 may also be configured to synchronize data 124 with connected FMS cloud services platform 120, using, for example, an application programming interface (API). In addition, FMS 602 may also be configured to synchronize data 122 with EFB applications 522. Thus, in some implementations, FMS 602 may be synchronized with data from both EFB 500 and platform 120 in real-time or at predetermined intervals, in such a way that the pilot 102 may rely on the on-board FMS 602 for all tasks arising in the environment 100.

A pilot 104, who may be on the ground, may also access EFB 500 and the EFB applications 522. In some implementations, the pilot 104 and the pilot 20 in the cockpit may be the same pilot, yet under different circumstances (e.g., time and location of the access). Additionally, or alternatively, the pilot 104 may be a different pilot, or another authorized member of the flight crew, who accesses EFB 500 on the ground for an official duty related to the connected FMS cloud services platform 120. While pilot 104 is accessing the EFB applications 522 via EFB 500, the EFB applications 522 may access the connected FMS cloud services platform 120 to receive various FMS services. In that way, EFB 500 may provide user-friendly and customized user interfaces, by which FMS services 126 from the connected FMS cloud services platform 120 may be serviced to pilot 104.

A dispatcher or other user may also access the connected FMS cloud services platform 120 through a dispatcher device 140. A dispatcher, in accordance with the present disclosure, may be any authorized personnel performing duties related to dispatching of aircraft in the environment 100. For example, a dispatcher may be an airline staff, an airport staff, air traffic control personnel, a ground control personnel, a member of a relevant aviation authority, or any other authorized person who may benefit from FMS services from the connected FMS cloud services platform 120 in performing their duties. Dispatcher device 140 may be any computing device capable of establishing a connection 128 to the cloud and interfacing with the connected FMS cloud services platform 120. While the dispatcher is accessing the FMS services via the dispatcher device 140, the dispatcher device 140 may access the connected FMS cloud services platform 120 to receive various FMS services. In that way, the dispatcher device 140 may provide user-friendly and customized user interfaces, by which FMS services from the connected FMS cloud services platform 120 may be serviced to the dispatcher.

FMS 602, EFB 500, and dispatcher device 140 may include one or more devices capable of receiving, generating, storing, processing, and/or providing information associated with FMS services. For example, FMS 602, EFB 500, or the dispatcher device 140 may include a communication and/or computing device, such as a mobile phone (e.g., a smart phone, a radiotelephone, etc.), a computer (e.g., a desktop computer, a laptop computer, a tablet computer, a handheld computer), a gaming device, a wearable communication device (e.g., a smart wristwatch, a pair of smart eyeglasses, etc.), or a similar type of device.

As part of facilitating communication between any of avionics 600, EFB 500, or FMS cloud services platform 120, the systems and devices may be configured to transmit and receive flight plans in the form of a .RTE (route) file, a .FPL file, or other file formats. As will be explained in more detail below, avionics 600, EFB 500, or FMS cloud services platform 120 may be configured to transmit and receive .RTE and .FPL files with some values obfuscated values rather than transmitting and receiving actual flight plans.

A .RTE file is a standard file format that may be used by FMS 602 and EFB applications 522 to store and exchange flight planning data. As will be illustrated in more detail below, .RTE files include some or all of sections for flight information, route details, altitude and speed information, fuel information, performance data, weather information, and other notes or remarks of interest to a pilot or other user. Each section then includes a field name and a value for the field name. A non-exhaustive list of fields that may be included in a .RTE file are FLIGHT_NUMBER, AIRCRAFT_TYPE, DEPARTURE_AIRPORT, DESTINATION_AIRPORT, ESTIMATED_DEPARTURE_TIME, ESTIMATED_ARRIVAL_TIME, WAYPOINTS, AIRWAYS, DEPARTURE_PROCEDURE, ARRIVAL_PROCEDURE, CRUISING_ALTITUDE, CLIMB_PROFILE, DESCENT_PROFILE, TOTAL_FUEL, TRIP_FUEL, RESERVE_FUEL, TAKEOFF_WEIGHT, LANDING_WEIGHT, ZERO_FUEL_WEIGHT, DEPARTURE_WEATHER, ARRIVAL_WEATHER, ENROUTE_WEATHER, PILOT_REMARKS, OPERATIONAL_NOTES.

Pilots (e.g., pilots 102 and 104) and dispatcher (e.g., a user of dispatch device 140) may use .RTE files to plan and file flight routes and ensure compliance with air traffic control and safety regulations. A .RTE file may be uploaded from EFB 500 to FMS 602 to provide necessary flight details for navigation and management during the flight. The interoperability of .RTE files may facilitate sharing of flight plans between different systems and stakeholders (e.g., airlines, airports, air traffic control). Instead of or in addition to .RTE files, FMS 602 and EFB applications 522 may exchange .FPL (flight plan) files, which include similar information as .RTE files and are used for similar purposes as .RTE files, but have a different formatting.

As indicated above, FIG. 1 is provided merely as an example. Other examples are possible and may differ from what was described with regard to FIG. 1. The number and arrangement of devices and networks shown in FIG. 1 are provided as an example. In practice, there may be additional devices, fewer devices and/or networks, different devices and/or networks, or differently arranged devices and/or networks than those shown in FIG. 1. Furthermore, two or more devices shown in FIG. 1 (e.g., EFB 500 and dispatcher device 140) may be implemented within a single device, or a single device shown in FIG. 1 (e.g., EFB 500, FMS 602, or dispatcher device 140) may be implemented as multiple, distributed devices. Additionally, or alternatively, a set of devices (e.g., one or more devices) of environment 100 may perform one or more functions described as being performed by another set of devices of environment 100.

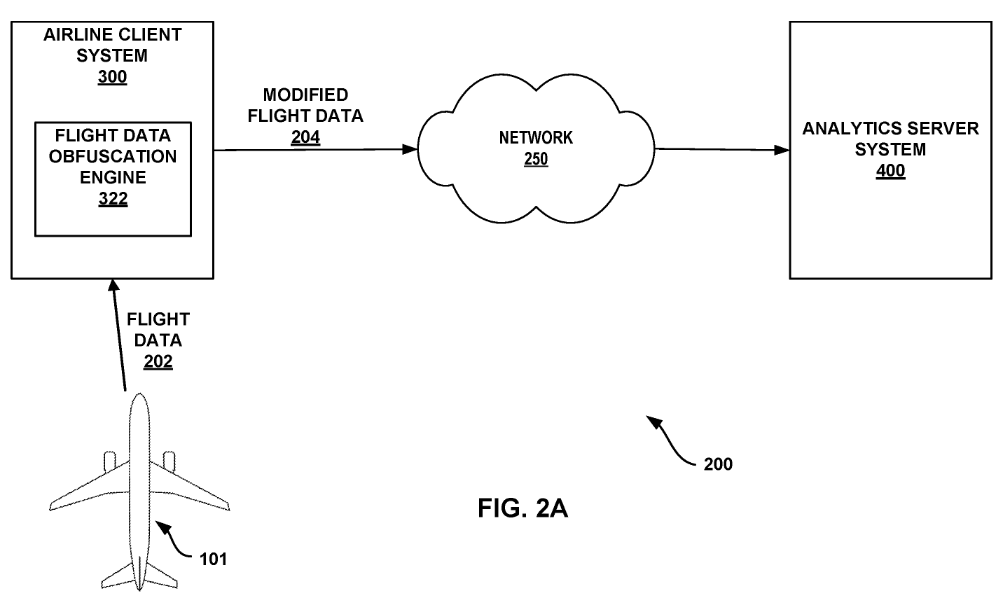

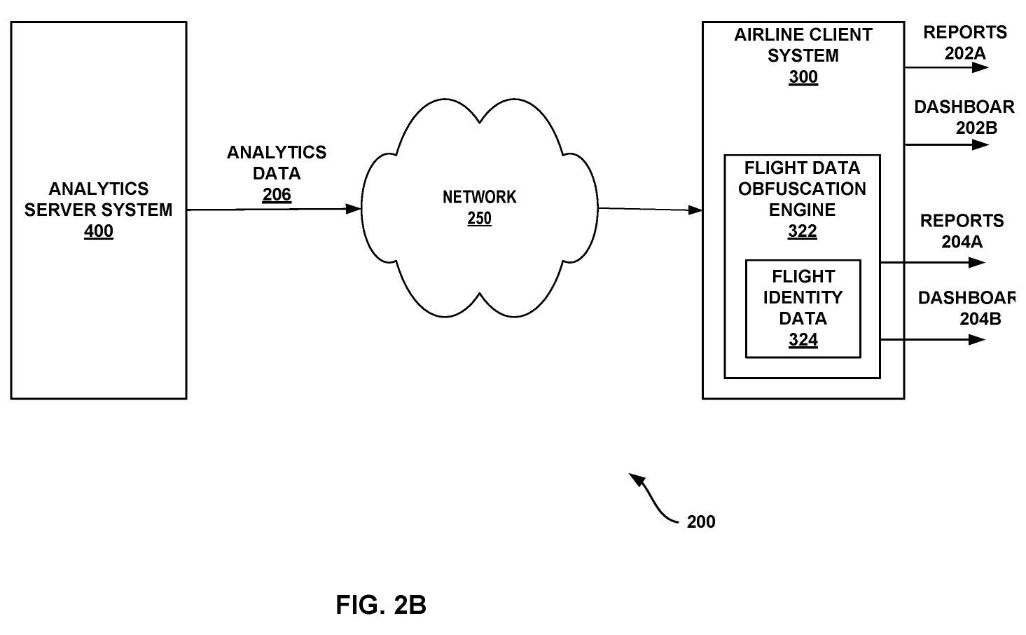

FIG. 2A shows a system 200 for uploading flight data 202 to a server system in accordance with the techniques of this disclosure. System 200 may be considered to be a subsystem of, or portion of, computing environment 100 described with respect to FIG. 1. System 200 includes airline client system 300, aircraft 101, and server system 400. Airline client system 300 may, for example, be hosted and managed by an airline or other owner of aircrafts. Airline client system 300 receives flight data 202 for a flight from aircraft 101. The flight data may include both flight identification data and parameter data. The flight identification data may, for example, include times and dates for the flight, names of pilots, a flight number, a plane identification number, or any other such information that may be used to associate the flight data with a specific flight. The flight identification may be acquired from aircraft 101 or from another source, such as EFB 500.

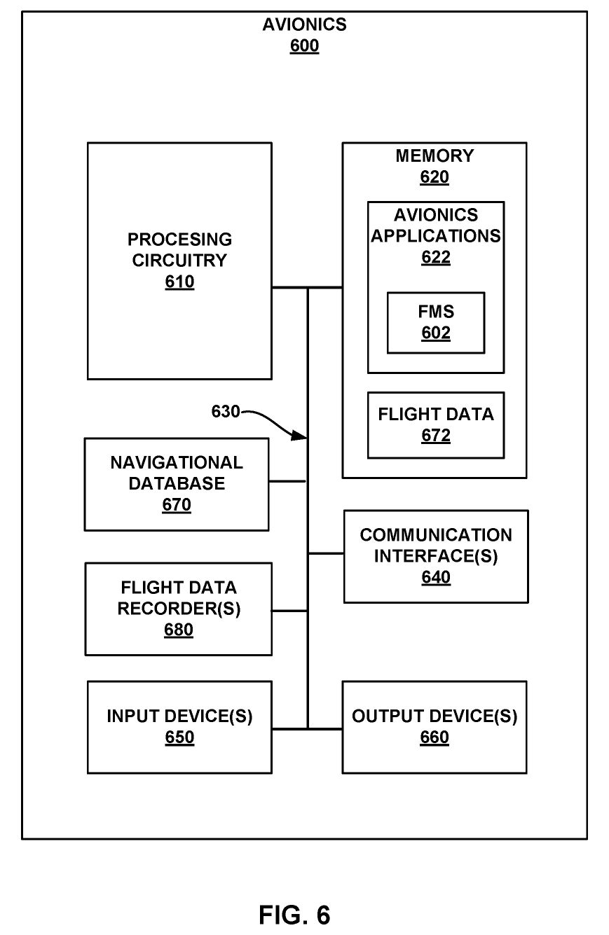

The parameter data may, for example, be data obtained from flight data recorder(s) 680 of FIG. 6 (described in more detail below) of aircraft 101 and may include values for a plurality of parameters, with each parameter being associated with a status of the aircraft and each of the values being associated with a timestamp. The parameter data may, for example, be in an ARINC 400 series format, such as ARINC 429. The parameter data may, for example, include a series of words, with each word having an X-bit label and a Y-bit value. The X-bit label identifies a parameter, and the Y-bit value identifies a value for the parameter. In this example, X and Y are positive integer values, such as 16 and 16, respectively, although other values for X and Y may also be used. Examples of parameters include airspeed, altitude, engine revolutions per minute (RPM), temperature, heading, pitch, roll, vertical speed, cabin pressure, fuel flow, and numerous other potential parameters described in more detail below.

The parameter data may, for example, also be in a 700 series format, such as ARINC 702, 717, or 767. The flight data may be organized into frames and subframes, with a frame, for example, representing one second of flight data, and each subframe corresponding to different parameters. Each parameter, such as altitude or airspeed, may have a designated bit location and bit length within a subframe.

Airline client system 300 may be configured to store and execute flight data obfuscation engine 322. Flight data obfuscation engine 322 may be configured to modify flight data 202 to generate modified flight data 204, and airline client system 300 may transmit, via network 250 for example, modified flight data 204 to analytics server system 400. Airline client system 300 may also receive, via network 250, flight analysis data (e.g., analytics data 206 in FIG. 2B) for modified flight data 204 from server system 400, and flight data obfuscation engine 322 may associate the flight analysis data with the flight. In some examples, flight data 202 and modified flight data 204 may include data from multiple flights of the same aircraft, multiple flights of different aircraft, or both.

To modify flight data 202, flight data obfuscation engine 322 may, for example, add an offset value to the timestamp associated with each value of parameter data or may set a value in the flight identification data to a default value. As an example of adding an offset value to the timestamp associated with each value of parameter data, flight data obfuscation engine 322 may add a certain amount of hours and/or minutes to every timestamp, such that the actual values of the timestamps change, but the sequencing of the timestamps does not change. By adding the offset, any third party in possession of the flight data could not match the flight data to a specific flight and, hence, to a specific crew. Flight data obfuscation engine 322 may similarly add offsets to other values, such as flight dates, flight numbers, or plane identification numbers.

As an example of setting a flight identification data value to a default value, flight data obfuscation engine 322 may change a pilot’s actual name to a generic descriptor such as Pilot 1, Pilot 2, etc., or may change plane identification number to a default value for a particular model of aircraft, such as 737 or A380. In some examples, flight data obfuscation engine 322 may also be configured to obfuscate or redact route information, such as take off and departure locations and waypoints.

Flight data obfuscation engine 322 may be configured to generate filtered data, e.g., modified flight data 204, in a standard format automatically in response to the airline uploading the raw data, e.g., flight data 202. For example, upon receiving flight data 202 from aircraft 101, flight data obfuscation engine 322 may be configured to automatically filter flight data 202, such that airline client system 300 can transmit modified flight data 204 to analytics server system 400 without requiring human input or authorization. That is, the receiving of flight data 202 by airline client system 300 may automatically trigger flight data obfuscation engine 322 to modify flight data 202 and transmit modified flight data 204 to analytics server system 400. In other examples, airline client system 300 may run flight data obfuscation engine 322 on flight data for a plurality of flights at specific time intervals, such as daily or twice daily.

Flight data obfuscation engine 322 may be configured to generate filtered data in a format that standardized for analytics server system 400. In this context, a standardized format may mean a standard set of fields and values corresponding to different types of flight data. Thus, flight data obfuscation engines other than flight data obfuscation engine 322 running on other airline client systems may generate modified flight data that is in the same format as that generated by flight data obfuscation engine 322. As one example, the standard format supported by analytics server system 400 may include fields for identifying an aircraft number. Some flight data obfuscation engines on other airline client systems may be configured to include the actual, or a modified, aircraft number. If, however, the operator of airline client system 300 wishes to redact the aircraft number, then flight data obfuscation engine 322 may be configured to insert a default value, such as XXXXX or 123456, into the aircraft number field. In this manner, the format of data received by analytics server system 400 is the same for both airline client system 300 and the other airline client systems, even though the different airline client systems have different policies related to including an aircraft number in the data.

The standard format may be any of JavaScript Object Notation (JSON), eXtensible Markup Language (XML), Electronic Data Interchange for Administration, Commerce, and Transport (EDIFACT), comma-separated values (CSV), Passenger and Airport Data Interchange Standards (IATA PADIS), Apache Avro, and Parquet formats. Thus, even if flight data obfuscation engine 322 is configured to receive flight data in a variety of formats, flight data obfuscation engine 322 may be configured to convert each of these disparate formats to a standard format, such that analytics server system 400 receives modified flight data in the standard format, or one of several different supported different standard formats.

Flight data obfuscation engine 322 may be customizable and modifiable by an airline employee. This customization may be a one-time event performed by airline personnel to guard the data integrity. The airline employee may, for example, customize what information from the flight data is redacted, modified, or not modified and how the information is redacted or modified.

FIG. 2B shows a system 200 for receiving analytics data from a server system in accordance with the techniques of this disclosure. As with system 200 of FIG. 2A, system 200 includes airline client system 300 and server system 400. Analytics server system 400 transmits analytics data, via network 250, to airline client system 300. Airline client system 300 may be configured to disseminate the analytics data, as reports 202A and dashboard 202B, to a first class of users. Reports 202A and dashboards 202B may, for example, not include any specific flight or crew information, and first class of users may be users who do not need specific flight or specific crew data.

Flight data obfuscation engine 322 may also be configured to perform de-obfuscation. That is, flight data obfuscation engine 322 may be configured to store flight identity data 324 that was removed or altered prior to transmitting flight data from airline client system 300 to analytics server system 400 and associate flight identity data 324 with the analytics data received from analytics server system 400. Flight data obfuscation engine 322 may be configured to generate reports 204A and dashboards 204B, which may include flight identity data 324 associated with the analytics data. Reports 204A and dashboards 204B may, for example, be disseminated to a second class of users, such as a pilot manager assessed with monitoring pilot performance.

Reports 202A and 204A may, for example, take the form of PDF files, spreadsheets, or some other format. Dashboards 202B and 204B may, for example, be visual interfaces that display information, metrics, and data insights in a consolidated format. Reports 202A and dashboards 202B may, for example, present historical data and trend analysis to help users understand patterns and make strategic decisions at a fleet level, route level, aircraft-type level, airport level, or the like. Reports 204A and dashboards 204B may, for example, present historical data and trend analysis to help users understand patterns and make strategic decisions at a pilot level, crew level, team level, or the like.

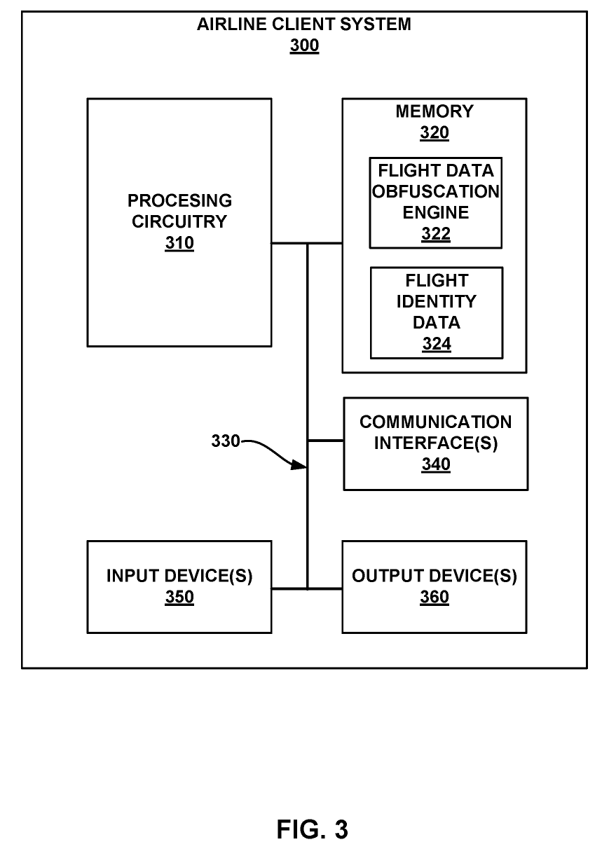

FIG. 3 illustrates an example of airline client system 300. Airline client system 300 represents generic computing hardware configured to store and execute flight data obfuscation engine 322. In the example of FIG. 3, airline client system 300 includes processing circuitry 310, memory 320 which stores flight data obfuscation engine 322 and modified flight data 324, communication interface(s) 340, input device(s) 350, and output device(s). The aforementioned components of airline client system 300 may be connected to one another through a bus 330, which generally represents one or more busses and is intended to generically represent all the electrical and data connectivity of internal components included within airline client system 300.

Processing circuitry 310 implements the functionality of and/or executes the instructions associated with flight data obfuscation engine 322. Processing circuitry 310 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware, or any combinations thereof. When the techniques are implemented partially in software, airline client system 300 may store instructions for the software in a suitable, non-transitory computer-readable medium (e.g., memory 320) and execute the instructions in hardware using processing circuitry 310 to perform the techniques of this disclosure.

Memory 320 is intended to generically represent all memory included within airline client system 300. In some implementations, memory 320 may include a plurality of separate devices and memory units. These memory devices and memory units may include volatile memory, such as random access memory (RAM), and/or non-volatile memory, such as ROM and storage media. Example of RAM include dynamic random access memory (DRAM), including synchronous DRAM (SDRAM), magnetoresistive RAM (MRAM), resistive RAM (RRAM). Examples of storage media include solid-state storage media (e.g., solid state drives and/or removable flash memory), optical storage media (e.g., optical discs), and/or magnetic storage media (e.g., hard disk drives). Flight data obfuscation engine 322 may be stored in any volatile and/or non-volatile memory component of memory 320 and executed by processing circuitry 310.

Communication interface(s) 340 generally represents all hardware, e.g., transceiver circuitry, within airline client system 300 for communicating with external devices. Communication interface(s) 340 may facilitate communication with external devices via one or more wired and/or wireless network connections by transmitting and/or receiving signals on the one or more networks. Examples of communication interface(s) 340 include a network interface card (e.g., such as an Ethernet card or WiFi card), an optical transceiver, a radio frequency transceiver, or any other type of device that can send and/or receive information. Other examples of communication interface(s) 340 may include short wave radios, cellular data radios, wireless network radios, as well as USB controllers.

Airline client system 300 also includes input device(s) 350 (e.g., a keyboard, mouse, or touchscreen) and output device(s) 360 (e.g., a display, printer). The various examples of input and output devices listed above represent a non-exhaustive list of the types of input and output devices that may be included in input device(s) 350 and output device(s) 360.

Processing circuitry 310 may be configured to receive, via communication interface(s) 340 for a flight, flight data that includes flight identification data and parameter data obtained from a flight data recorder of an aircraft. Flight data obfuscation engine 322, being executed by processing circuitry 310, may modify the flight data to generate modified flight data by detecting a field in the flight data and changing a value associated with the field. Flight data obfuscation engine 322 may, for example, detect the field based on a bit location inside a subframe or based on a label value.

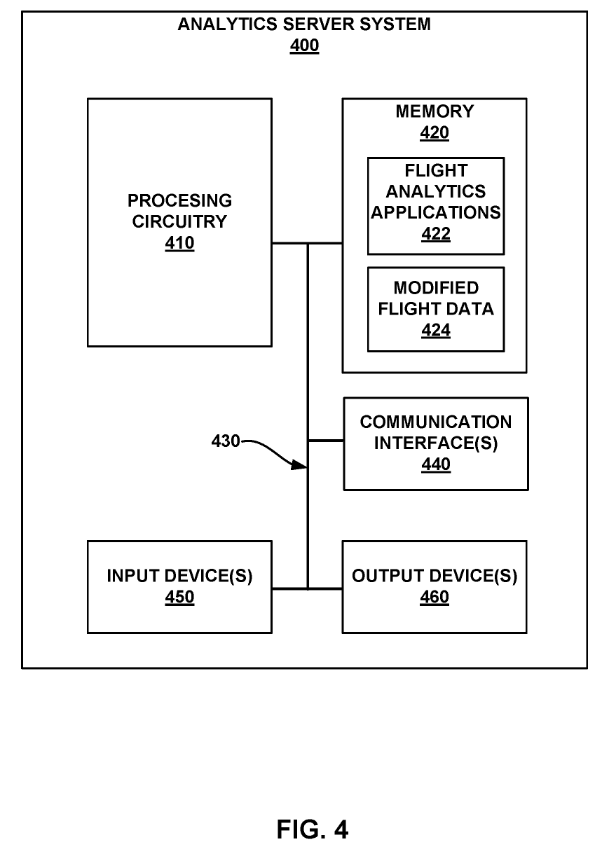

Processing circuitry 310 may store the flight identity data as flight identity data 324 in memory 320 and transmit, via communications interface(s) 340, the modified flight data to analytics server system 400. Processing circuitry 310 may include in the modified flight data identification information that associates the modified flight data with flight identity data 324. The identification information may be any unique value or number that can be associated with flight identity data 324 without revealing the actual content of flight identity data 324. Processing circuitry 310 receives, from analytics server system 400 via communication interface(s) 340, flight analysis data for the modified flight data. The flight analysis data may, for example, include fuel efficiency data or any combination or permutation of the types of flight analysis data described below with respect to FIG. 4. The flight analysis data may include the identification information, such that airline processing circuitry 310 may associate the flight analysis data with the flight identification data.

In some examples, processing circuitry 310 may be configured to aggregate multiple instances of flight analysis data for different groups. For example, upon receiving flight analysis data for a specific flight, airline client system 300 may associate the flight analysis data with a specific crew, specific pilot, specific route, etc. identifiable from the flight identification and add the flight analysis data to other flight analysis already obtained for that specific crew, specific pilot, specific route, etc. In other examples, upon receiving flight analysis data for a specific flight, airline client system 300 may associate the flight analysis data with a different group, such as a fleet or aircraft type, that is determinable from the flight analysis data itself rather than the flight identification data.

Airline client system 300 may be configured to generate two or more different classes of reports or dashboards. The first class may include more flight identity data than the second class. For example, the first class may include analysis for a specific crew or pilot, whereas the second class includes analysis for a full fleet or aircraft type within the fleet.

Although airline client system 300 is shown in the example of FIG. 3 as being a single device, in many implementations, the functionality attributed to airline client system 300 may be performed across multiple devices. For example, one device may receive and modify the flight data, while a different device receives the flight analysis data for the modified flight data, associates the flight analysis data with the flight identification data, and generates a dashboard based on the flight analysis data and the flight identification data.

FIG. 4 illustrates an example of analytics sever system 400. Analytics server system 400 represents generic computing hardware configured to store and execute flight analytics applications. In the example of FIG. 4, analytics sever system 400 includes processing circuitry 410, memory 420 which stores flight analytics applications 422 and modified flight data 424, communication interface(s) 440, input device(s) 450, and output device(s). The aforementioned components of analytics sever system 400 may be connected to one another through a bus 430, which generally represents one or more busses and is intended to generically represent all the electrical and data connectivity of internal components included within analytics sever system 400.

Processing circuitry 410 implements the functionality of and/or executes the instructions associated with flight analytics applications 422. Processing circuitry 610 may be implemented as any of a variety of suitable circuitry that includes a processing system, such as one or more integrated circuits, microprocessors, DSPs, ASICs, FPGAs, discrete logic, software, hardware, firmware, or any combinations thereof. When the techniques are implemented partially in software, analytics server system 400 may store instructions for the software in a suitable, non-transitory computer-readable medium (e.g., memory 420) and execute the instructions in hardware using processing circuitry 410 to perform the techniques of this disclosure.

Memory 420 is intended to generically represent all memory included within analytics server system 400. In some implementations, memory 420 may include a plurality of separate devices and memory units. These memory devices and memory units may include volatile memory, such as RAM, and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). Flight analytics applications 422 may be stored in any volatile and/or non-volatile memory component of memory 420.

Communication interface(s) 440 generally represents all hardware, e.g., transceiver circuitry, within analytics server system 400 for communicating with external devices. Communication interface(s) 440 may facilitate communication with external devices via one or more wired and/or wireless network connections by transmitting and/or receiving signals on the one or more networks. Examples of communication interface(s) 440 include a network interface card (e.g., such as an Ethernet card or WiFi card), an optical transceiver, a radio frequency transceiver, or any other type of device that can send and/or receive information. Other examples of communication interface(s) 440 may include short wave radios, cellular data radios, wireless network radios, as well as USB controllers.

Analytics server system 400 also includes input device(s) 450 (e.g., a keyboard, mouse, or touchscreen) and output device(s) 460 (e.g., a display, printer). The various examples of input and output devices listed above represent a non-exhaustive list of the types of input and output devices that may be included in input device(s) 450 and output device(s) 460.

Flight analytics applications 422 represent a suite of software tools for evaluating modified flight data 424 to provide insights across various performance metrics that may be used by an airline or aircraft fleet owner to potentially improve operational efficiency, reduce fuel costs, and enhance overall flight performance.

Flight analytics applications 422 may, for example, analyze modified flight data 424 to determine the fuel efficiency of the flights. For example, flight analytics applications 422 may measure fuel consumption across different flight phases to determine fuel burn rates and identify flight phases where fuel-saving procedures can be applied. Flight analytics applications 422 may also track fuel usage during taxiing to provide insights into potential reductions, such as determining auxiliary power unit usage to identify opportunities to use ground power instead of APU power.

Flight analytics applications 422 may also analyze modified flight data 424 to perform flight plan optimization and determine how much an actual flight path might have deviated from a preferred flight path. Flight analytics applications 422 may, for example, determine if the aircraft was flown at the optimal altitude for fuel and time efficiency and determine if the aircraft adhered to optimal cruising speeds to minimize fuel burn. Flight analytics applications 422 may also identify deviations from the optimal or filed flight route.

Flight analytics applications 422 may also analyze modified flight data 424 to determine descent and climb efficiency. For example, flight analytics applications 422 may determine if the aircraft used a fuel-inefficient descent profile or determine the aircraft used a fuel-inefficient climb profile to determine if the aircraft used excess fuel during initial ascent. Flight analytics applications 422 may also analyze modified flight data 424 to determine time efficiency including on-time performance (e.g., on-time departure and arrival) and the time taken between landing and subsequent departure to determine turnaround time efficiency.

Flight analytics applications 422 may also analyze modified flight data 424 to determine weather and wind impact. For example, flight analytics applications 422 may analyze wind conditions against flight path choices to determine if optimal winds were utilized and monitor the impact of weather diversions on fuel burn and time efficiency.

Flight analytics applications 422 may also analyze modified flight data 424 to determine operational compliance. Examples of operational compliance include adherence to standard operating procedures and compliance with airline operational standards. Flight analytics applications 422 may also analyze modified flight data 424 to determine landing performance, such as whether descent rate and braking efficiency correspond to an optimal or acceptable landing profile. Flight analytics applications 422 may also analyze modified flight data 424 to determine whether single-engine taxi procedures were used when possible to save fuel.

Flight analytics applications 422 may also analyze modified flight data 424 to determine environmental impact by, for example, tracking carbon dioxide output based on fuel usage for each flight, helping airlines stay within emission targets. Flight analytics applications 422 may also analyze modified flight data 424 for noise abatement compliance to confirm that noise-reducing procedures were implemented in designated zones, including descent rates and flap settings.

Flight analytics applications 422 may also analyze modified flight data 424 to determine cost metrics, such as direct operating costs and maintenance cost projections. A direct operating cost may, for example, be determined based on metrics such as fuel burn, route efficiency, and time savings to assess the cost of operations. Maintenance cost projections may be determined based on tracking engine and component usage to help estimate potential maintenance costs.

Processing circuitry 410 may include a cloud-based API gateway to manage and secure communication between airline client system 300 and flight analytics applications 422. The API gateway may, for example, be configured to receive requests and send responses to airline client system 300.

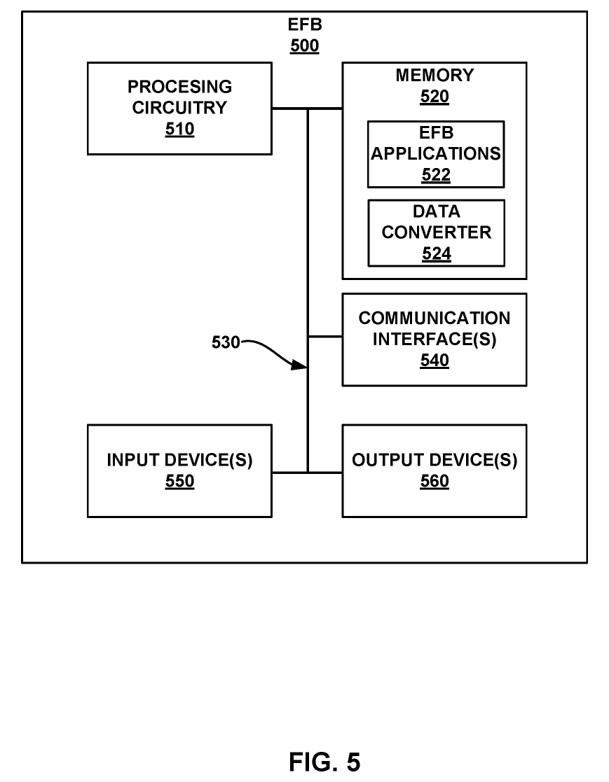

FIG. 5 illustrates an example of EFB 500. EFB 500 may be any sort of generic computing hardware, such as a tablet computer, phone, laptop computer, desktop computer, or other such computing device that is configured to store and execute EFB applications. In other examples, EFB 500 may be specialized computing hardware configured to store and execute EFB applications. Some EFBs may be portable and be able to be carried from plane to plane, while other EFBs may be permanently mounted in a specific airplane. In the example of FIG. 5, EFB 500 includes processing circuitry 510, memory 520 which stores EFB applications 522 and data converter 524, and communication interface(s) 540 to communicate with other devices.

Processing circuitry 510 implements the functionality of and/or executes the instructions associated with EFB applications 522. Processing circuitry 510 may be implemented as any of a variety of suitable circuitry that includes a processing system, such as one or more integrated circuits, microprocessors, DSPs, ASICs, FPGAs, discrete logic, software, hardware, firmware, or any combinations thereof. When the techniques are implemented partially in software, EFB 500 may store instructions for the software in a suitable, non-transitory computer-readable medium (e.g., memory 520) and execute the instructions in hardware using processing circuitry 510 to perform the techniques of this disclosure.

Memory 520 is intended to generically represent all memory included within EFB 500. In some implementations, memory 520 may include a plurality of separate devices and memory units. These memory devices and memory units may include volatile memory, such as RAM), and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned EFB application (shown in FIG. 5 as EFB applications 522) may be stored in any volatile and/or non-volatile memory component of memory 520.

EFB 500 also includes input device(s) 550 (e.g., a keyboard, mouse, or touchscreen) and output device(s) 560 (e.g., a display, printer). In implementations where EFB 500 is a phone or tablet computer, then the EFB may, for example, have a touchscreen and a display. In implementations where EFB 500 is a larger computer device, then the EFB may, for example, have a mouse, trackpad, keyboard, or other such input devices. The aforementioned components of EFB 500 may be connected to one another through a bus 530, which generally represents one or more busses and is intended to generically represent all the electrical and data connectivity of internal components included within EFB 500.

Communication interface(s) 540 generally represents all hardware, e.g., transceiver circuitry, within EFB 500 for communicating with external devices. Communication interface(s) 540 may facilitate communication with external devices via one or more wired and/or wireless network connections by transmitting and/or receiving signals on the one or more networks. Examples of communication interface(s) 540 include a network interface card (e.g., such as an Ethernet card), an optical transceiver, a radio frequency transceiver, a GPS receiver, or any other type of device that can send and/or receive information. Other examples of communication interface(s) 540 may include short wave radios, cellular data radios, wireless network radios, as well as universal serial bus (USB) controllers. In some examples, communication interface(s) 540 may include an avionics full-duplex switched ethernet (AFDX) interface, also known as ARINC 664.

EFB applications 522 represent a suite of software tools that may be used by a pilot in managing flight operations. EFB applications 522 may include flight planning applications that allow pilots to create and file flight plans, access weather information, and calculate fuel requirements. EFB applications 522 may also include navigation applications that provide real-time navigation support with maps, airspace information, and waypoint management. EFB applications 522 may also include weather applications that provide real-time weather data, future weather predictions, radar imagery, and the like. EFB applications 522 may also include checklist applications for ensuring compliance with pre-flight, mid-flight, and post-flight procedures. EFB applications 522 may also include various performance analysis tools that, for example, help pilots compute takeoff and landing distances based on current conditions and aircraft configuration. EFB applications 522 may also include aircraft maintenance tracking tools that track aircraft maintenance schedules, inspection records, and compliance records. EFB applications 522 may also include flight logbooks that enable pilots to log flights, track hours, and generate reports for currency and certification. EFB applications 522 may also include airport information applications that provide information about airports, including runway layouts, services, and notices.

The various example applications listed above represent a non-exhaustive list of the types of applications that may be included in EFB applications 522. As explained above, some applications of EFB applications 522 may facilitate communication with avionics 600 using the data communication techniques of this disclosure.

FIG. 6 illustrates an example of avionic 600. Avionics 600 is specialized computing hardware configured to store and execute avionics applications. In the example of FIG. 6, avionics 600 includes processing circuitry 610, memory 620 which stores avionics applications 622, communication interface(s) 640 to communicate with other devices, such as EFB 500, input device(s) 650, output device(s) 660, navigational database 670, and flight data recorder(s) 680. The aforementioned components of avionics 600 may be connected to one another through a bus 630, which generally represents one or more busses and is intended to generically represent all the electrical and data connectivity of internal components included within avionics 600.

Processing circuitry 610 implements the functionality of and/or executes the instructions associated with avionics applications 622. Processing circuitry 610 may be implemented as any of a variety of suitable circuitry that includes a processing system, such as one or more integrated circuits, microprocessors, digital signal processors (DSPs), application specific integrated circuits (ASICs), field programmable gate arrays (FPGAs), discrete logic, software, hardware, firmware, or any combinations thereof. When the techniques are implemented partially in software, avionics 600 may store instructions for the software in a suitable, non-transitory computer-readable medium (e.g., memory 620) and execute the instructions in hardware using processing circuitry 610 to perform the techniques of this disclosure.

Memory 620 is intended to generically represent all memory included within avionics 600. In some implementations, memory 620 may include a plurality of separate devices and memory units. These memory devices and memory units may include volatile memory, such as RAM, and/or non-volatile memory, such as ROM and storage media. Example of RAM include DRAM, including SDRAM, MRAM, RRAM. Examples of storage media include solid-state storage media (e.g., solid state drives and/or removable flash memory), optical storage media (e.g., optical discs), and/or magnetic storage media (e.g., hard disk drives). The aforementioned avionics application (shown in FIG. 6 as avionics applications 622) may be stored in any volatile and/or non-volatile memory component of memory 620.

Communication interface(s) 640 generally represents all hardware e.g., transceiver circuitry, within avionics 600 for communicating with external devices either on the ground or while in flight. Communication interface(s) 640 may facilitate communication with external devices via one or more wired and/or wireless network connections by transmitting and/or receiving signals on the one or more networks. Examples of communication interface(s) 640 include a network interface card (e.g., such as an Ethernet card), an optical transceiver, a radio frequency transceiver, a GPS receiver, or any other type of device that can send and/or receive information. Other examples of communication interface(s) 640 may include short wave radios, cellular data radios, wireless network radios, as well as USB controllers. Examples of communication interface(s) 640 for in-flight communication include a very high frequency (VHF) radio, a high frequency (HF) radio, or a satellite communication (SATCOM) radio.

Examples of communication interface(s) 640 used for data links include an aircraft communications addressing and reporting system (ACARS) for providing a digital data link system that allows for the exchange of messages between the aircraft and ground stations for purposes such as flight plan updates, weather information, and maintenance reports. Another examples of communication interface(s) 640 used for data links include controller-pilot data link communications (CPDLC) which allows air traffic control to send instructions and receive acknowledgments from pilots via text messages. Communications interface(s) 640 may also include an automatic dependent surveillance-broadcast transponder. The various examples of communications interfaces listed above represent a non-exhaustive list of the types of communication interfaces that may be included in communication interface(s) 640.

Avionics 600 also includes input device(s) 650 and output device(s) 660. Examples of input device(s) 650 include control display units (CDUs) with alphanumeric keypads or touchscreens to enter flight plans, waypoints, and other necessary data. Input device(s) 650 may also include an FMS control panel for entering information to the FMS, such as route, altitude, and speed using dedicated buttons, knobs, and touchscreen interfaces. Input device(s) 650 may also include yoke or sidestick controls as well as touchscreen interfaces. Input device(s) 650 may also include rotary knobs for setting values for altitudes, speeds, and other parameters and toggle switches for selecting modes or turning systems on and off.

Examples of output device(s) 660 may include an electronic flight instrument display to provide visual representations of flight data, including altitude, airspeed, heading, and attitude. Output device(s) 660 may also include a Heads-Up Display (HUD) that projects critical flight information onto a transparent screen in the pilot's line of sight or other cockpit displays to show navigation maps, engine parameters, system statuses, and the like. Output device(s) 660 may also include engine instrumentation displays to display data on engine performance, such as temperature, pressure, and revolutions per minute (RPMs). Output device(s) 660 may also include audio panels to relay communication from radios and alerts from systems to the cockpit. Output device(s) 660 may also include an FMS display to show flight plan information and performance data, as well as a traffic collision avoidance system (TCAS) display to alert pilots to nearby aircraft and potential collision threats.

The various examples of input and output devices listed above represent a non-exhaustive list of the types of input and output devices that may be included in input device(s) 650 and output device(s) 660. Additionally, input and output functionality of avionics 600 may facilitated by external devices that are separate from input device(s) 650 and output device(s) 660. For example, EFB 500 may be configured to input data to and output data for avionics 600.

Avionics applications 622 represent a suite of software tools that may be used by a pilot in managing flight operations and managing the aircraft while in flight. Avionics applications 622 includes FMS 602 discussed above as well as other applications for communication, navigation, and monitoring within an aircraft. Avionics applications 622, for example, include applications for processing and displaying weather radar data and presenting essential flight information such as altitude, airspeed, attitude, and heading to a pilot. Avionics applications 622 also include various safety applications related to surveillance systems (e.g., transponders to communicate the aircraft’s identity and altitude to air traffic control and other aircraft, such as automatic dependent surveillance-broadcast (ADS-B) systems that provide real-time data to air traffic control and other aircraft). Avionics applications 622 may also include the software to manage various emergency systems (e.g., an emergency locator transmitter, flight data recorder, and cockpit voice recorder) and cabin management systems (e.g., passenger infotainment systems and environmental control systems).

Navigational database 670 represents a specialized database that stores information needed by FMS 602 for the navigation and operation of an aircraft for purposes such as flight planning, route management, and ensuring safe navigation throughout a flight. Navigational database 670 may, for example, store waypoints, airways, navigational aids, airport information, standard instrument departures (SIDs) and standard terminal arrival routes (STARs), route data, and flight plans. The waypoints represent information on predefined geographical locations used for navigation, including both en-route waypoints and arrival/departure waypoints. The airways are data defining structured flight paths in the sky, including various air routes and connecting points. The navigational aids may, for example, be information on radio beacons, such as VHF Omnidirectional Range and Instrument Landing Systems that assist pilots in navigation. The airport information may, for example, include details about airports, including runway configurations, elevation, communications frequencies, and available approaches. SIDs and STARs may provide standardized paths for departures and arrivals. The route data may, for example, include information on preferred routes, including distance and estimated times. The flight data may be data regarding planned routes, altitudes, and waypoints for a specific flight. The locations of waypoints, airports, and navigational aids may, for example, be defined by geographical coordinates.

Navigational database 670 may also store information related to restrictions and procedures, performance data, and weather information. The restrictions and procedures may include airspace restrictions, no-fly zones, and specific procedures that need to be followed during flight. The performance data may include information related to aircraft performance, including altitude constraints, and speed limits. The weather information may include relevant meteorological data that might affect flight paths, such as wind patterns or turbulence zones. Navigational database 670 may be regularly updated to reflect changes in air traffic regulations, airport information, and navigational aids to ensure pilots have current information for safe and efficient flight operations.

Although not explicitly shown in FIG. 6, avionics 600 may include or be in communication with numerous other hardware components or hardware systems, such as a global positioning system (GPS) receiver, an inertial navigation system (INS) that includes gyroscopes and accelerometers to calculate position based on movement, weather radar for detecting weather patterns, engine monitoring systems, aircraft data recording systems, flight data recording systems, and other such systems. In some examples, avionics 600 may be configured to utilize inputs from a variety of specialized sensors such as altitude sensors, airspeed sensors, attitude sensors, heading sensors, GPS sensors, temperature sensors, pressure sensors, fuel sensors, weight and balance sensors, navigation sensors, environmental sensors, collision avoidance sensors, and other such sensors.

Flight data recorder(s) 680 may be configured to record, and store in memory 620, flight data 682. In some examples, flight data recorder(s) 680 may have dedicated memory, meaning the memory that stores flight data 682 is separate than, for example, the memory that stores avionics applications 622. Flight data recorder(s) 680 may include any combination of one or more flight data recorders including a quick access recorder, a deployable recorder, or a combined cockpit voice recorder and flight data recorder.

Flight data recorder(s) 680 may be configured to record flight dynamics and motion data. For example, flight data recorder(s) 680 may be configured to record the aircraft’s altitude above sea level (i.e., altitude), the aircraft’s speed relative to the surrounding air (i.e., airspeed), the aircraft’s rate of ascent or descent (i.e., vertical speed), the direction the aircraft is pointed (i.e., heading), the aircraft’s nose angle up/down and bank angle left/right (i.e., pitch and roll), the aircraft’s deviation from a straight path or wind drift (i.e., yaw), and the aircraft’s lateral, vertical, and longitudinal acceleration.

Flight data recorder(s) 680 may also be configured to record control surfaces and positioning data. For example, flight data recorder(s) 680 may be configured to record the aircraft’s aileron position for controlling roll, the aircraft’s elevator position for controlling pitch, the aircraft’s rudder position for controlling yaw, the aircraft’s flap positions for controlling changes in lift and drag (e.g., during takeoff, landing, and approach), the aircraft’s spoiler positions for reducing lift and slowing the aircraft down, or the aircraft’s slat positions for providing added lift during low-speed operations.

Flight data recorder(s) 680 may also be configured to record engine parameters. For example, flight data recorder(s) 680 may be configured to record the aircraft’s engine output (e.g., engine thrust or power level), the aircraft engine’s core and fan shaft speeds (i.e., N1 and N2 speeds), temperature of gases exiting the engine (e.g., exhaust gas temperature (EGT)), the rate at which fuel is consumed by each engine (i.e., fuel flow rate), oil Pressure, oil temperature, and thrust level set by the pilot (e.g., throttle position).

Flight data recorder(s) 680 may also be configured to record environmental conditions data. For example, flight data recorder(s) 680 may be configured to record outside air temperature, the presence of ice on wings or other critical surfaces, storm and weather information, and wind speed and direction.

Flight data recorder(s) 680 may also be configured to record aircraft systems and equipment data. For example, flight data recorder(s) 680 may be configured to record autopilot Status, such whether autopilot is engaged and what mode (altitude hold, heading mode, etc.) is being implemented. Flight data recorder(s) 680 may also be configured to record the position of the landing gear (e.g., up, down, or transit), brake pressure or braking force applied during landing, hydraulic pressure of braking systems, and cabin altitude and pressurization levels. Flight data recorder(s) 680 may also be configured to record electrical systems status, such as voltage, current, and operational state of systems.

Flight data recorder(s) 680 may also be configured to record flight path and navigation data, such as GPS position (e.g., latitude, longitude, and altitude coordinates), horizontal track and descent/ascent angles (i.e., flight path angle and track), speed relative to the ground (i.e., groundspeed), and navigation waypoints in the flight plan.

Flight data recorder(s) 680 may also be configured to record crew inputs. For example, flight data recorder(s) 680 may be configured to record control inputs, such as a pilot’s inputs on yoke/stick, rudder pedals, and throttle. Flight data recorder(s) 680 may also be configured to record status or positions of switches (e.g., fuel pumps, anti-ice). Flight data recorder(s) 680 may also be configured to record communication controls, such as transponder codes, frequency changes, and communications status.

Flight data recorder(s) 680 may also be configured to record the status of warning and alarm systems, such as the status of alarms such as stall warnings, overspeed warnings, or terrain awareness warnings. Flight data recorder(s) 680 may also be configured to record engine and system alerts, such as malfunction notifications related to engine failures, low hydraulic pressures, or other such warnings. Flight data recorder(s) 680 may also be configured to record crew announcements and chimes.

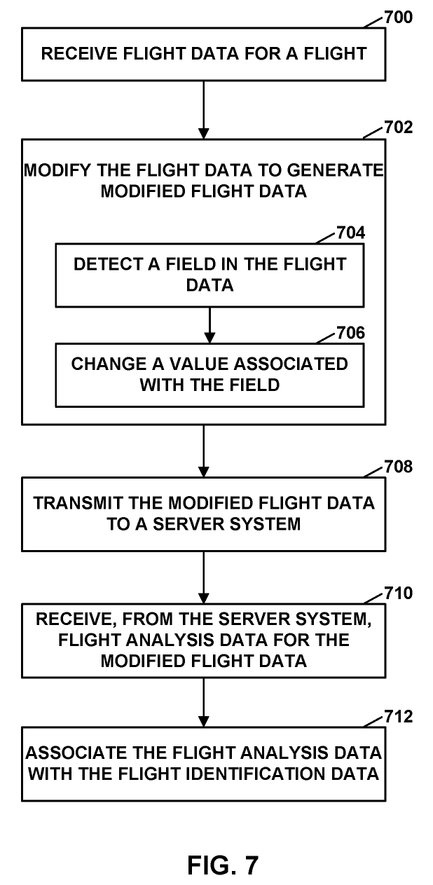

FIG. 7 is a flowchart showing an example process for communicating with an analytics server in accordance with techniques of this disclosure. The process will be described with respect to airline client system 300 and analytics server system 400, but the techniques of FIG. 7 are not limited to specific systems or devices.

Airline client system 300 receives flight data for a flight (700). The flight data may, for example, include flight identification data and parameter data obtained from a flight data recorder of an aircraft. The flight identification data may include a flight number, crew information, route information, or other such information that may be used to identify a flight crew that flew the flight. The parameter data may include values for a plurality of parameters, with each of the plurality of parameters being associated with a status of the aircraft and each of the values being associated with a timestamp.

Airline client system 300 modifies the flight data to generate modified flight data (702). Airline client system 300 may modify the flight data by redacting or modifying values of the parameter data. Airline client system 300 may additionally or alternatively modify the flight data by converting the flight data to a standard format. The standard format may include both a standard set of parameters, as well as a standard file format for transmitting the parameters and associated values. The standard file format may, for example, be JSON, CSV, XML, or any other such file format including a proprietary format known to both airline client system 300 and analytics server system 400. To modify the flight data, airline client system 300 may detect a field in the flight data (704) and change a value associated with the field (706).

Airline client system 300 transmits the modified flight data to analytics server system 400 (708). Airline client system 300 may also store the flight identification data and store a unique identifier associated with the flight identification data. The unique identifier may be randomly generated, generated serially, or may be extracted in some manner from the flight data itself.

Airline client system 300 receives, from analytics server system 400, flight analysis data for the modified flight data (710). The flight analysis data may, for example, be fuel efficiency data or any other type of flight analysis data described herein. Airline client system 300 associates the flight analysis data with the flight identification data (712). Airline client system 300 may, for example, determine a unique identifier for the flight analysis data and match the flight analysis data to flight identification data. By matching the flight analysis data to the flight identification data using the unique identifier, airline client system 300 may apply the flight analysis data to specific routes, specific pilots, or specific crews. Airline client system 300 may, for example, add the newly received flight analysis data for the specific route, specific pilot, or specific crew, to previously received flight analysis data for the specific route, specific pilot, or specific crew. By accumulating data in this manner, airline client system 300 may be able to accumulate flight analysis data from analytics server 400 over a period of time for the specific route, specific pilot, or specific crew without analytics server 400, or another third party, ever having sufficient information to accurately identify the specific route, specific pilot, or specific crew.

The following numbered clauses illustrate one or more aspects of the devices and techniques described in this disclosure.

Clause 1. A computer-implemented method of uploading flight data to a server system, the method comprising: receiving, by a client computing system, flight data for a flight, wherein the flight data includes flight identification data and parameter data obtained from a flight data recorder of an aircraft, wherein the parameter data comprises values for a plurality of parameters, each of the plurality of parameters being associated with a status of the aircraft and each of the values being associated with a timestamp; modifying, by a flight data obfuscation engine executing on the client computing system, the flight data to generate modified flight data, wherein modifying the flight data comprises: detecting a field in the flight data; and changing a value associated with the field; and transmitting the modified flight data to the server system.

Clause 2: The method of clause 1, further comprising: receiving, from the server system, flight analysis data for the modified flight data; and associating, by the flight data obfuscation engine, the flight analysis data with the flight identification data.

Clause 3: The method of clause 2, further comprising: storing identification information for the flight identification data, wherein associating the flight analysis data with the flight identification data comprises determining the identification information from the flight analysis data.

Clause 4: The method of clause 2 or 3, further comprising: aggregating the flight analysis data with other flight analysis data based on the associating of the flight analysis data with the flight identification data.

Clause 5: The method of any of clauses 2-4, further comprising: generating, for display, a dashboard based on the flight analysis data and the flight identification data.

Clause 6: The method of any of clauses 1-5, wherein modifying the flight data comprises adding an offset value to the timestamp of each value.

Clause 7: The method of any of clauses 1-6, wherein modifying the flight data comprises setting a value in the flight identification data to a default value.

Clause 8: The method of any of clauses 1-7, wherein modifying the flight data comprises converting the parameter data to a specified format, and transmitting the modified flight data to the server system comprises transmitting the modified flight data in the specified format.

Clause 9: The method of any of clauses 1-8,wherein the parameter data comprises a plurality of words, each word having an X-bit label and a Y-bit value, wherein the X-bit label identifies a parameter type and the Y-bit value identifies a value for the parameter type, wherein X and Y are positive integer values.

Clause 10: The method of any of clauses 1-8, wherein the parameter data comprises a plurality of frames, each frame of the plurality of frames having a plurality of subframes, wherein a location within a subframe indicates a parameter type and bit values in the location identify a value for the parameter.

Clause 11. A client system for uploading flight data to a server system, the client system comprising: one or more memories; and processing circuitry coupled to the one or more memories and configured to: receive flight data for a flight, wherein the flight data includes flight identification data and parameter data obtained from a flight data recorder of an aircraft, wherein the parameter data comprises values for a plurality of parameters, each of the plurality of parameters being associated with a status of the aircraft and each of the values being associated with a timestamp; modify the flight data to generate modified flight data, wherein to modify the flight data, the processing circuitry is configured to: detect a field in the flight data; and change a value associated with the field; and transmit the modified flight data to the server system.

Clause 12: The client system of clause 11, wherein the processing circuitry is further configured to: receive, from the server system, flight analysis data for the modified flight data; and associate the flight analysis data with the flight identification data.

Clause 13: The client system of clause 12, wherein the processing circuitry is further configured to: store identification information for the flight identification data, wherein to associate the flight analysis data with the flight identification data, the processing circuitry is further configured to determine the identification information from the flight analysis data.

Clause 14: The client system of clause 12 or 13, wherein the processing circuitry is further configured to: aggregate the flight analysis data with other flight analysis data based on the associating of the flight analysis data with the flight identification data.

Clause 15: The client system of any of clauses 12-14, wherein the processing circuitry is further configured to: generate, for display, a dashboard based on the flight analysis data and the flight identification data.

Clause 16: The client system of any of clauses 11-15, wherein to modify the flight data, the processing circuitry is further configured to add an offset value to the timestamp of each value.

Clause 17: The client system of any of clauses 11-15, wherein to modify the flight data, the processing circuitry is further configured to set a value in the flight identification data to a default value.

Clause 18: The client system of any of clauses 11-17, wherein to modify the flight data, the processing circuitry is further configured convert the parameter data to a specified format, and transmitting the modified flight data to the server system comprises transmitting the modified flight data in the specified format.

Clause 19: The client system of any of clauses 11-18,wherein the parameter data comprises a plurality of words, each word having an X-bit label and a Y-bit value, wherein the X-bit label identifies a parameter type and the Y-bit value identifies a value for the parameter type, wherein X and Y are positive integer values.

Clause 20: The client system of any of clauses 11-18, wherein the parameter data comprises a plurality of frames, each frame of the plurality of frames having a plurality of subframes, wherein a location within a subframe indicates a parameter type and bit values in the location identify a value for the parameter.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A computer-implemented method of uploading flight data to a server system, the method comprising:
receiving, by a client computing system, flight data for a flight, wherein the flight data includes flight identification data and parameter data obtained from a flight data recorder of an aircraft, wherein the parameter data comprises values for a plurality of parameters, each of the plurality of parameters being associated with a status of the aircraft and each of the values being associated with a timestamp;
modifying, by a flight data obfuscation engine executing on the client computing system, the flight data to generate modified flight data, wherein modifying the flight data comprises:
detecting a field in the flight data; and
changing a value associated with the field; and
transmitting the modified flight data to the server system.

2. The method of claim 1, further comprising:
receiving, from the server system, flight analysis data for the modified flight data; and
associating, by the flight data obfuscation engine, the flight analysis data with the flight identification data.

3. The method of claim 2, further comprising:
storing identification information for the flight identification data, wherein associating the flight analysis data with the flight identification data comprises determining the identification information from the flight analysis data.

4. The method of claim 2, further comprising:
aggregating the flight analysis data with other flight analysis data based on the associating of the flight analysis data with the flight identification data.

5. The method of claim 2, further comprising:
generating, for display, a dashboard based on the flight analysis data and the flight identification data.

6. The method of claim 1, wherein modifying the flight data comprises adding an offset value to the timestamp of each value.

7. The method of claim 1, wherein modifying the flight data comprises setting a value in the flight identification data to a default value.

8. The method of claim 1, wherein modifying the flight data comprises converting the parameter data to a specified format, and transmitting the modified flight data to the server system comprises transmitting the modified flight data in the specified format.

9. The method of claim 1,wherein the parameter data comprises a plurality of words, each word having an X-bit label and a Y-bit value, wherein the X-bit label identifies a parameter type and the Y-bit value identifies a value for the parameter type, wherein X and Y are positive integer values.

10. The method of claim 1, wherein the parameter data comprises a plurality of frames, each frame of the plurality of frames having a plurality of subframes, wherein a location within a subframe indicates a parameter type, and bit values in the location identify a value for the parameter.

11. A client system for uploading flight data to a server system, the client system comprising:
one or more memories; and
processing circuitry coupled to the one or more memories and configured to:
receive flight data for a flight, wherein the flight data includes flight identification data and parameter data obtained from a flight data recorder of an aircraft, wherein the parameter data comprises values for a plurality of parameters, each of the plurality of parameters being associated with a status of the aircraft and each of the values being associated with a timestamp;
modify the flight data to generate modified flight data, wherein to modify the flight data, the processing circuitry is configured to:
detect a field in the flight data; and
change a value associated with the field; and
transmit the modified flight data to the server system.

12. The client system of claim 11, wherein the processing circuitry is further configured to:
receive, from the server system, flight analysis data for the modified flight data; and
associate the flight analysis data with the flight identification data.

13. The client system of claim 12, wherein the processing circuitry is further configured to:
store identification information for the flight identification data, wherein to associate the flight analysis data with the flight identification data, the processing circuitry is further configured to determine the identification information from the flight analysis data.

14. The client system of claim 12, wherein the processing circuitry is further configured to:
aggregate the flight analysis data with other flight analysis data based on the associating of the flight analysis data with the flight identification data.

15. The client system of claim 12, wherein the processing circuitry is further configured to:
generate, for display, a dashboard based on the flight analysis data and the flight identification data.

16. The client system of claim 11, wherein to modify the flight data, the processing circuitry is further configured to add an offset value to the timestamp of each value.

17. The client system of claim 11, wherein to modify the flight data, the processing circuitry is further configured to set a value in the flight identification data to a default value.

18. The client system of claim 11, wherein to modify the flight data, the processing circuitry is further configured convert the parameter data to a specified format, and transmitting the modified flight data to the server system comprises transmitting the modified flight data in the specified format.

19. The client system of claim 11, wherein the parameter data comprises a plurality of words, each word having an X-bit label and a Y-bit value, wherein the X-bit label identifies a parameter type and the Y-bit value identifies a value for the parameter type, wherein X and Y are positive integer values.

20. The client system of claim 11, wherein the parameter data comprises a plurality of frames, each frame of the plurality of frames having a plurality of subframes, wherein a location within a subframe indicates a parameter type, and bit values in the location identify a value for the parameter.
